(19) United States
(12) Patent Application Publication
(10) Pub. No.: US 2011/0284658 A1
(43) Pub. Date: Nov. 24, 2011

(54) 3D ROTOR SPRINKLER

(76) Inventor: Edward S. CHANG, DIAMOND BAR, CA (US)

(21) Appl. No.: 12/785,748

(22) Filed: May 24, 2010

(51) Int. Cl. B05B 3/04; B05B 3/16; A01G 25/00

(52) U.S. Cl. 239/201; 239/210; 239/240; 239/242

(57) ABSTRACT

Improvements in a sprinkler head where the sprinkler head can deliver a single stream of water droplets in a three dimensional direction and then precipitate equally onto any selected terrain area which minimally scatters the water droplets. The solid stream nozzle can shoot the water stream in a preset partial arc as well as 360 degrees while the sprinkler head rotates in a horizontal circular direction to cover an equal precipitation on an entire irrigation area. The 3D Rotor consists of the vertically swivel turret which is moved vertically to change the trajectory angle by the rotating cam integrated with the turbine and reduction gear. The solid stream nozzle can deliver the water stream in a radial direction range which is changed by the angle of the trajectory which is then changed by the rotating cam containing a calculated curve.

### CROSS REFERENCE TO RELATED APPLICATION

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in a sprinkler. More particularly, the present 3D Rotor Sprinkler is a rotating sprinkler that further includes a spray nozzle that vertically oscillates to provide a more constant application of water to an irrigation area. This invention relates to the 3D Rotor sprinkler head that consists of the three dimensional, moving solid stream nozzle sprinkler system which is delivering the water droplet with the variable radial direction, and while this occurs, the sprinkler head is turning in a horizontal direction with a preselected arc and range or 360 degrees in a full circle.

2. Description of Related Art including information Disclosed Under 37 CFR 1.97 and 1.98

This system is most ideal to have equal precipitation of the irrigation water in a designated area because of the water droplets being delivered in an equal amount per designated area in any given time. Furthermore, the characteristic of the solid stream nozzle can deliver water efficiently with low atmospheric air resistance, evaporation, and wind effect since the solid stream nozzle is delivering a single stream of water. Therefore, it can shoot a longer distance with less scatter under the same inlet water pressure. Several products and patents have been. Exemplary examples of patents covering these products are disclosed herein.

U.S. Pat. No. 5,372,307 issued Dec. 13, 2004 to George Sesser discloses a Rotary Sprinkler Stream Interrupter. This sprinkler uses a solid water stream that sprays onto a rotating head. The rotating head has a plurality of slots where each slot diverts the solid water stream into a different direction. This patent does not include a head that both pivots and rotates to evenly cover an irrigation area.

U.S. Pat. No. 4,925,098 issued May 15, 1990 to Jan Di Paola discloses an Underground-Installable Rotary Spray Irrigation Device, with Emission Angle Selectable from the Top. While the emission angle of this sprinkler is adjustable, the emission angle does not change as the sprinkler rotates. The angle is adjusted while the sprinkler is not in operation.

U.S. Pat. No. 7,427,038 issued Sep. 23, 2008 to Po-Hsiung Wang et al., discloses a Dual-Axis Rotating Sprinkler. The head of the sprinkler rotates over the top center of the sprinkler and further includes a plurality of different spray nozzles. While the head can rotate is two axes, the configuration of the head does not permit the spray head to be placed in an irrigation area because the top of the head is exposed and susceptible to damage as well as harm to people.

What is needed is an underground installable sprinkler where the solid stream spray nozzle can rotate up and down as well as rotate around to provide more even distribution of irrigation water.

### BRIEF SUMMARY OF THE INVENTION

It is an object of the 3D Rotor sprinkler has many advantages with wide spread use in the irrigation Industries. There is a need to irrigate large areas such as golf courses, parks, ball fields, playgrounds and agriculture crop growing areas.

3D Rotor sprinkler is well suited in residential or small landscape areas as well because of its controllable precipitation, radius, arc and distance by its tight control of three dimensional solid streams.

Therefore 3D Rotor sprinkler head will save substantial amount of irrigation water with equal precipitation, tight control of watering, eliminate over watering, minimize runoff, less evaporation losses in the atmosphere, less wind effect during the spraying, less watering time, and operate in low inlet water pressure.

It is accordingly an object of this invention to provide the “3D Rotor” three dimensional directions moving nozzle in which is rotating in a horizontal direction by the reversible driving gear which is integrated with the turbine and reduction gear. Then the driving cam moves the swivel turret in a vertical direction that is associated with the driving turbine and reduction gear mounted on the rotating sprinkler head. This 3 dimensional movement of the nozzle will deliver the water stream in an X.Y.Z. axis and makes the water with equal precipitation in an irrigation area during a spraying, and solid stream nozzle to reduce atmospheric resistance, wind effect, scattered water droplet, evaporation rate, over watering and to control the runoff. Therefore, this 3D Rotor will deliver the water droplet in longer distance with equal amounts of water in designated areas in given time and under the same inlet water pressure. This result will save the substantial amount of irrigation water with improved watering condition.

It is also an object of this invention to provide the 3D Rotor the solid stream nozzle consistently moves in a vertical direction by the driving cam to make a changing trajectory angle which varies the distance of water shooting distance in the range covers from 0 to maximum desired radius while the sprinkler head rotate horizontal direction in circle.

It is also an object of this invention to provide the 3D Rotor sprinkler head is rotated in a horizontal direction and reciprocating in preset arc or full circle in 360 degree by the integrated driving gear train and the turbine. The preset arc adjustment screw head is located on top of the sprinkler head.

It is also an object of this invention to provide the solid stream nozzle shooting the water in a solid stream to reduce evaporation in the atmosphere by minimizing the scattered water droplets and to prevent a wind effect unlike an ordinary spraying-type sprinkler. This solid stream nozzle can be adapted to the unique 3D Rotor which delivers the water in an X.Y.Z. axis and precipitation to an entire irrigation area. The solid stream nozzle is interchangeable in different sizes for a different flow rate.

It is also an object of this invention to provide the 3D Rotor sprinkler head can be operated by relatively lower water pressure because of the character of solid stream jet nozzle can shoot longer distance under same water pressure.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a top view of a first preferred embodiment of a 3D rotor sprinkler system assembly.

FIG. 2 shows a cross section side view of the first preferred embodiment of a 3D rotor sprinkler system assembly.

FIG. 3 shows a top view of a second preferred embodiment of a 3D rotor sprinkler system assembly.

FIG. 4 shows a cross section side view of the second preferred embodiment of a 3D rotor sprinkler system assembly.

FIG. 5 shows a cross sectional side view of a 3D rotor sprinkler assembly, with the vertically swivel turret assembly mounted on the horizontally rotate head which is integrated to the riser stem assembly.

FIG. 6 is a cross section top view of a 3D Cannon Rotor sprinkler system assembly with the vertically swivel cannon ball joint assembled on the horizontally rotate head which is integrated to the lower body.

### DETAILED DESCRIPTION OF THE INVENTION

FIG. 1 to FIG. 4 shows is a cross-section side view and top view of a 3D Rotor sprinkler system assembly, with the vertically swivel turret assembly mounted on the horizontally rotate head which is integrated to the riser stem assembly. The 3D Cannon Rotor sprinkler is consists of a preset arc adjustment device, turbine wheel, gear reducer, horizontal rotate gear, reciprocating trip mechanism, vertically oscillating mechanism, crank wheel, and worm gear.

The 3D Rotor sprinkler consists of the drive mechanism and the components of the preset arc adjustment device. The outer protective casing or stationary lower body 26 consists of a water inlet connector, retractable coil spring 38, seal and seal cover 37. The riser stem consists of a tubular body 27, a screen filter 34, a pressure regulator 32, a turbine wheel 30, a speed control vale 31, a gear reducer 29, a horizontal rotate gear 28, reciprocating trip mechanism, and an arc setting device 50. One key element of the 3D rotor is a vertically swivel turret which is driven by the rotating cam 16 integrated with the turbine 53 and speed reduction gear 52. The swivel turret consists of the turning pivot bearing, the arm lever with the cam follower, the water inlet connector with the rotary joint and the flow control valve. The groove of the cam is designed to move the swivel turret in an equal area covered by a variable trajectory angle change.

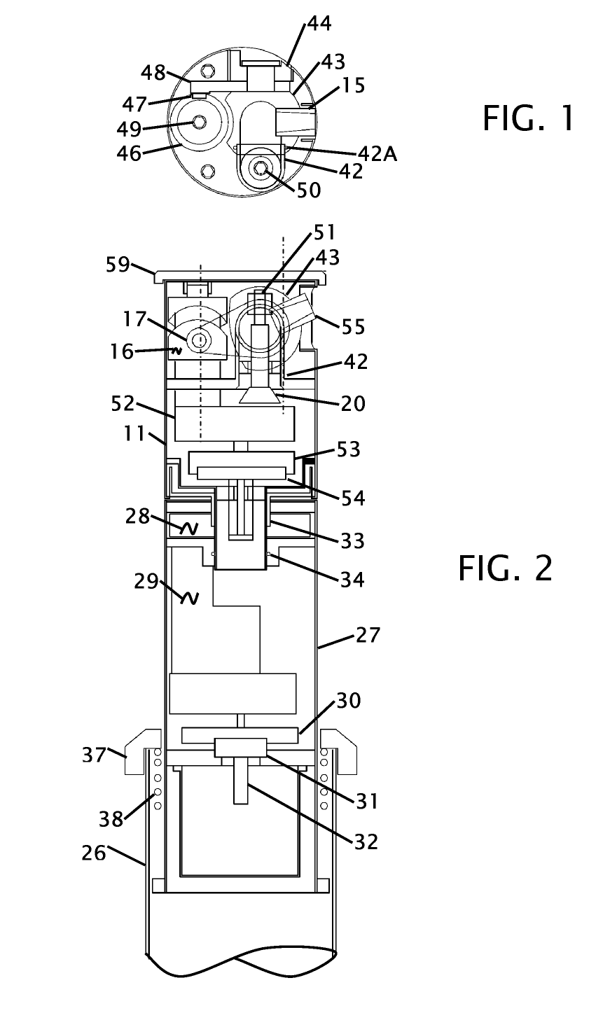

FIG. 1 shows a top view of a first preferred embodiment of a 3D rotor sprinkler system assembly and FIG. 2 shows a cross section side view of the first preferred embodiment of a 3D rotor sprinkler system assembly. From FIGS. 1 and 2, show a horizontally rotatable sprinkler upper head assembly or outer casing body 11 mounted on a riser stem assembly 27 which integrates a rotary drive mechanism 28 consisting of a turbine 30, a speed controller 31, a reduction gear train 29, an inlet water pressure regulator 32, a connecting bearing assembly 33 and an inlet water screen 34

The horizontal rotatable sprinkler upper head assembly includes a upper head assembly 11, a vertically swivel turret 43, a support pivot bearing assembly 44, a arm lever 48, a cam follower 47, an activating drum cam 46, an angle adjustment device 49, a cam driving gear reducer 52, a turbine 53, a speed control 54, a solid jet stream nozzle 55, an inlet water conduit 42 with rotary joint 42A, a water flow control valve 51 where the valve is controlled with a screw located on top of head and a protective cover 59.

The vertical swivel turret 43 is moving vertically within a support pivot bearing assembly 44, that is connected to the rotary joint 42A and an inlet water conduit 42, whereby changing the trajectory angle of the jet nozzle that is driven by the activating drum cam 46, and then the solid jet stream nozzle 55 shoots the single stream of water delivering to cover radial direction. The solid jet stream nozzle is controlled with worm gear 20.

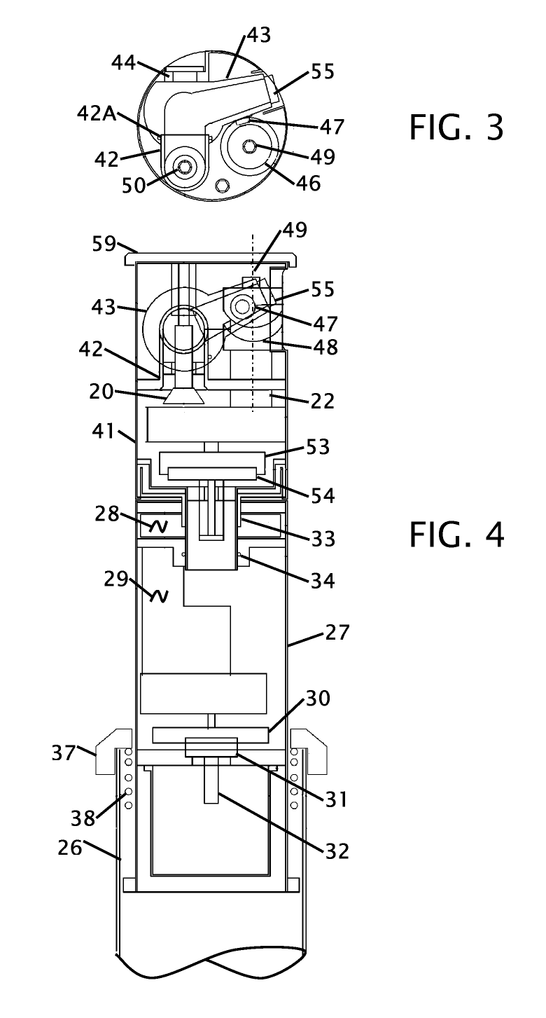

FIG. 3 shows a top view of a second preferred embodiment of a 3D rotor sprinkler system assembly and FIG. 4 shows a cross section side view of the second preferred embodiment of a 3D rotor sprinkler system assembly. From FIGS. 3 and 4 the 3D cannon rotor represents the cannon style sprinkler which is ideal for applications that require long distance throw. From these figures the 3D cannon rotor sprinkler has a rotatable sprinkler upper head assembly 11 mounted on a stationary lower body 26 which integrates a rotary drive mechanism 28 consisting of the turbine 30, a speed controller 31, the reduction gear train 29, a reversible horizontal head driving gear 22, and a preset able arc adjustment device 49.

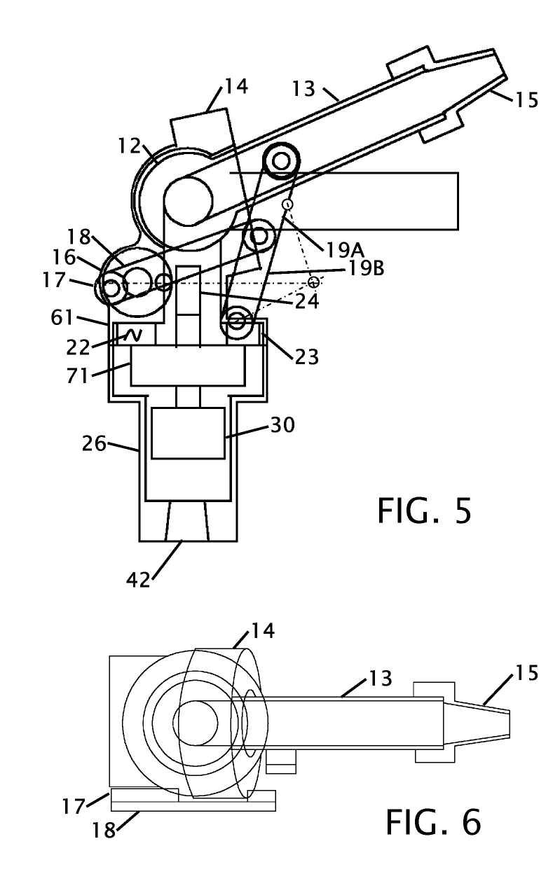

FIG. 5 shows a cross sectional side view of a 3D rotor sprinkler assembly, with the vertically swivel turret assembly mounted on the horizontally rotate head which is integrated to the riser stem assembly. FIG. 6 is a cross section top view of a 3D Cannon Rotor sprinkler system assembly with the vertically swivel cannon ball joint assembled on the horizontally rotate head which is integrated to the lower body.

The cannon vertical oscillating mechanism as shown in FIGS. 5 and 6 includes a driving worm 24 that is connected to turbine and reduction gear 17, a rotating crank 16, a connecting rod 18 and linkages 19 that are further identified a links 19A and 19B. The horizontal rotatable sprinkler upper head assembly 61 having a water inlet conduit 42 is shown mounted on stationary lower body 26 which integrates a rotary drive mechanism 71, consist of a turbine 30, a reduction gear, a reversible horizontal head driving gear 22 and a preset able arc adjustment device 23. The cannon vertical oscillating mechanism consist of the driving worm 24 that is connected to turbine and reduction gear 17, a rotating crank 16, a connecting rod 18 with linkages 19A and 19B.

The 3 D Cannon rotor further includes a rotary ball joint 12, a ball joint casing 14, a water conduit 13 and an interchangeable solid stream nozzle tip 15 where the tip is selected based upon the desired flow rate. The interchangeable solid jet stream nozzle 55 has different sizes for different flow rate of water that is determined according to the kind of irrigation park area, condition of soil, and type of grass.

Thus, specific embodiments of a 3D cannon rotor sprinkler have been disclosed. It should be apparent, however, to those skilled in the art that many more modifications besides those described are possible without departing from the inventive concepts herein. The inventive subject matter, therefore, is not to be restricted except in the spirit of the appended claims.

1. A 3D Rotor Sprinkler comprising:
a horizontal rotatable upper head assembly;
a support lower body having a water inlet;
said support lower body integrates at least one rotary driving mechanism, at least one turbine, at least one reduction gear, at least one rotating gear, a reversing mechanism and an oscillating mechanism;
a vertically swivel jet nozzle turret that is oscillating vertically up and down with a vertical trajectory angle to deliver a solid water stream thru a jet nozzle which moves vertical to said horizontal rotatable upper head, and
said vertically swivel jet nozzle oscillates vertically to change said vertical trajectory angle within a range while said vertically swivel jet nozzle turret rotates horizontally in a partial arc or a full 360 degree circle.

2. The 3D Rotor sprinkler according to claim 1 wherein said multiple jet nozzles on the swivel turret and has a multi level turret construction.

3. The 3D Rotor sprinkler according to claim 1 wherein said vertically swivel jet nozzle turret mechanism that is assembled on said rotating head is connect to a rotary water conduit.

4. The 3D Rotor sprinkler according to claim 1 wherein said vertically swivel jet nozzle turret operates with a cam mechanism that has a cam groove in a circumference which activates a cam follower and then a move arm lever of said swivel turret.

5. The 3D Rotor sprinkler according to claim 1 wherein said vertically swivel jet nozzle turret operates a piston mechanism that has a water flow control valve.

6. The 3D Rotor sprinkler according to claim 3 wherein said vertically swivel jet nozzle turret pivots on a bearing assembly which supports said swivel jet nozzle turret with a said rotary joint water conduit with a seal.

7. The 3D Rotor sprinkler according to claim 4 wherein said cam follower is bolted on said arm lever.

8. The 3D Rotor sprinkler according to claim 4 wherein said cam follower moves up and down as said cam follows said cam groove to drive said vertically swivel jet nozzle in a vertical motion.

9. The 3D Rotor sprinkler according to claim 3 wherein said rotary water conduit further includes a joint connected to said vertically swivel jet nozzle turret that carries water.

10. The 3D Rotor sprinkler according to claim 3 that further includes an interchangeable solid stream nozzle that delivers a solid stream of water.

11. The 3D Rotor sprinkler according to claim 4 wherein said driving cam mechanism moves said vertically swivel jet nozzle turret up and down and further consist of said at least one reduction gear, a train and said at least one turbine which is turned by inlet water flow.

12. The 3D Rotor sprinkler according to claim 4 wherein said driving cam mechanism has a speed control adjustment mechanism located on top of said upper head assembly.

13. The 3D Rotor sprinkler according to claim 4 wherein said driving cam mechanism has an angle adjustment located on top of said upper head assembly.

14. The 3D Rotor sprinkler according to claim 5 wherein said water flow control valve is located at said water conduit and is adjusted by a control screw located on top of said upper head assembly.

15. The 3D Rotor sprinkler according to claim 1 wherein said horizontal rotatable upper head assembly receives said vertically swivel jet nozzle turret, said swivel jet nozzle turret, said cam mechanism, a support bearing, an inlet water conduit, a horizontal arc adjustment screw, a speed control adjustment mechanism, a water flow adjustment screw and a protect cover.

16. The 3D Rotor sprinkler according to claim 1 that further includes a horizontal arc angle preset mechanism that consists of a gear, a trip finger and an angle adjustable screw.

17. The 3D Rotor sprinkler according to claim 1 that further includes a head horizontally rotate gear integrated with a gear reducer and a turbine wheel which is turning by water flow and is governed by a speed controller.

18. The 3D Rotor sprinkler according to claim 1 that further includes an inlet water screen to prevent entry of unwanted debris.

19. The 3D Rotor sprinkler according to claim 18 that further includes a riser stem comprising of said water inlet, connecting bearings for said rotating head, said at least one reducing gear, said at least one turbine, a speed controller, said inlet water screen, a return spring and at least one turning seal.

20. The 3D Rotor sprinkler according to claim 1 that further includes a protective outer sprinkler casing for connection to a water supply line that carries pressurized water for deliver to jet nozzle, and consist of a seal, a cap, a return spring that holds a sprinkler stem to riser under water pressure and is restricted by a spring force from said return spring.
